(19) United States
(12) Patent Application Publication
(10) Pub. No.: US 2001/0042053 A1
(43) Pub. Date: Nov. 15, 2001

(54) Postage meter machine, and method and system for enabling a postage meter machine

(75) Inventors: Andreas Wagner, Berlin (DE); Olav A. Zarges, Berlin (DE)

Correspondence Address: Schiff Hardin & Waite, Patent Department, 233 South Wacker Drive -6600 Floor Sears Tower, Chicago, IL, 60606, US

(73) Assignee: Francotyp-Postalia AG & Co.

(21) Appl. No.: 09/855,120

(22) Filed: May 14, 2001

(30) Foreign Application Priority Data
May 12, 2000 (DE) 100 23 145.4

(51) Int. Cl. G06F 17/00

(52) U.S. Cl. 705/401

(57) ABSTRACT

In a method and system for enabling a postage meter machine for franking postal matter, the postage meter machine having a base unit, a meter for the control and debiting of franking, and a printer unit, with an identification code, in order to satisfy the postal requirements of treating the printer unit like a meter and assuring a long duration of the current location of the printer unit, even when it is located outside the meter, as well as to prevent manipulations, the postage meter machine, after the coupling of base unit and meter and before initialization, is coupled to the data center, and that the identification code is transmitted to the data center. An enable code is transmitted from the data center to the postage meter machine for enabling the postage meter machine to generate frankings.

### BACKGROUND OF THE INVENTION

1. Field of the Invention

The present invention is directed to a method for enabling a postage meter machine for franking postal matter, the machine being of the type having a base unit, a meter for controlling and debiting franking, and a printer unit, the printer unit having an identification code. The invention also is directed to a system for franking postal matter having a data center and at least one postage meter machine, as well as being directed to a postage meter machine by itself.

2. Description of the Prior Art

From the point of view of preventing postal fraud, postage meter machines are composed of two components in need of protection, namely an accounting unit for the postal registers and a printer unit for producing the franking imprint. The postal registers must be protected against unauthorized modification; the printing unit must be protected against unauthorized use, particularly against the generation of franking imprints without or with too low a debiting. The meter is subject to specific postal-related handling rules, such as the length of time at the current location, contractual obligations between the customer and the postal service, and possibly a requirement for regular postal inspections.

The introduction of digital printing, specifically ink jet printing, requires that the ink jet head be located out of the meter due to design constraints. This is true for permanent print heads as well as for disposable print heads. Digital printing allows the application of variable data in the franking imprint. This can be utilized in order to design each franking imprint to be unique. Moreover, cryptographic codes can assure the authenticity and integrity of the printed data. The physical protection of the printer unit is thus replaced by a logic protection of the data contents of the franking imprint.

Postal authorities, however, continue to have the need and the requirement of treating the printer unit like a meter and assuring the continued tenure of the current location.

### SUMMARY OF THE INVENTION

An object of the present invention is to provide a method, a system and a postage meter machine for franking postal matter that meet the aforementioned demands, that, in particular, enable a lengthy duration of usage of the printer unit, even when this is located outside the meter.

This object is inventively achieved in a method, system and a postage meter machine wherein, after the meter is coupled to a new base unit that, in particular, includes the entire mechanism of the postage meter machine for the transport of the postal matter and for generating franking imprints as well as the printer unit, a data connection is inventively set up with a data center preceding the commissioning before the postage meter machine can be put into operation as intended and frankings can be generated. Such a data center is already provided in known mail processing systems in order to register data about registered postage meter machines and, for example, to reload postage values for generating frankings into a local postage meter machine via a remote query line. Inventively, the identification code is transmitted to this data center in order to register the current location of the printer unit thereat and thus to also register the base unit. Insofar as there are no entries at the data center indicating possible manipulations at the printer unit or the postage meter machine itself, and there are no other grounds for impeding the commissioning of the postage meter machine, a corresponding enable code is returned to the postage meter machine, after which the postage meter machine is placed in operation and is enabled for generating frankings. This enable procedure is implemented before commissioning as well when the meter is removed from a postage meter machine and introduced into a new postage meter machine.

The same procedure can be implemented when a new printer unit is introduced into a postage meter machine.

Inventively, thus, the current location of the printer unit, and thus of the base unit as well, is registered in the data center. Given this method, which is referred to as “base tracking”, printer units that have been manipulated or with which manipulations are to be suspected can be prevented from being used for generating frankings when corresponding entries are present in the data center.

Preferably, the printer unit has a print head with a serial number serving as the identification code that, in an embodiment, is assigned upon manufacture of the print head and is stored in an electronic memory, for example a non-volatile memory such as an EEPROM, arranged at the print head.

In a further embodiment a remote recrediting ensues when the postage meter machine is coupled to the data center, with a data transmission in addition to the transmission of the identification code. This can prevent a simulation of a manipulation of a postage meter machine by a third party since the transmission of the identification code is implemented following a cryptographically protected transmission, namely the remote recrediting.

The transmission of the identification code also can ensue in cryptographically protected form.

### DESCRIPTION OF THE DRAWINGS

FIG. 1 is a block diagram of an inventive system for franking postal matter.

FIGS. 2A and 2B illustrate transmission protocols between the postage meter machine and data center in the identification phase in accordance with the invention.

FIGS. 3A and 3B illustrate transmission protocols between the postage meter machine and the data center in the data transmission phase in accordance with the invention.

### DESCRIPTION OF THE PREFERRED EMBODIMENTS

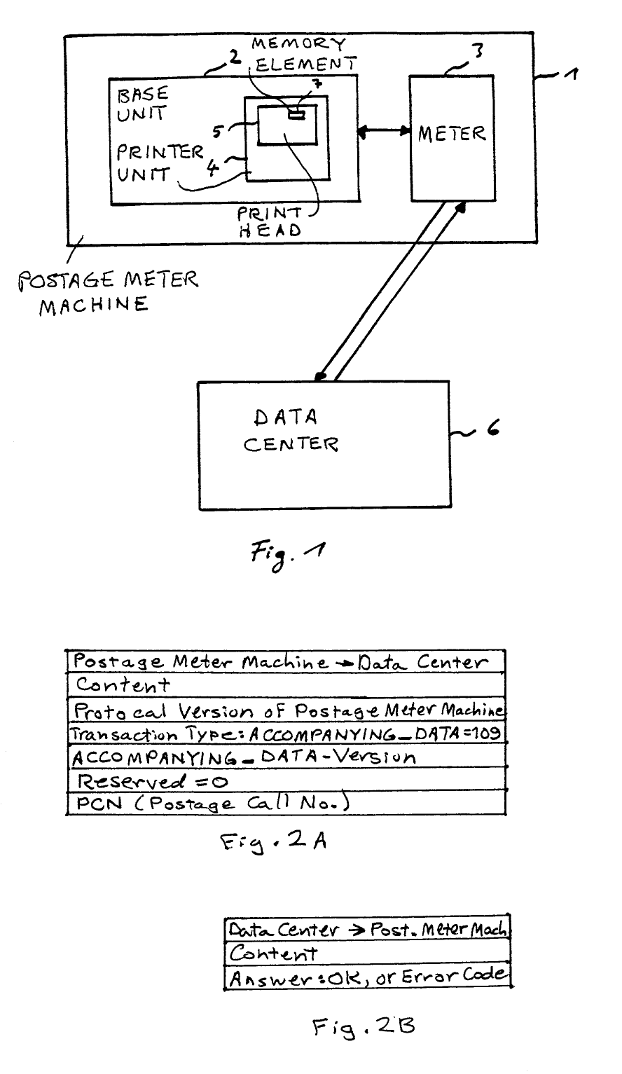

FIG. 1 shows a block diagram of a system for franking postal matter according to the invention, having a postage meter machine 1 and a data center 6. The postage meter machine 1 has a base unit 2 and a meter 3 that are coupled to one another. In addition to a number of elements that are not shown, particularly for the transport of the postal matter and for generating the franking imprints, the base unit 2 also has a printer unit 4 with a print head 5. A memory element 7 in which a unique serial number is stored is arranged at or in the print head 5.

When the meter 3, which particularly serves for debiting frankings, for storing postage values and for controlling the postage meter machine 1, is coupled to the base unit 2 for the first time and the postage meter machine 1 is to be subsequently placed in operation for generating frankings, a data connection is first set up with the data center 6. This data connection preferably exists between the meter 3 to the data center 6 via, for example, a modem, but alternatively can ensue wirelessly to the data center 6 via a mobile radiotelephone connection. The meter 3 then recognizes the new serial number of the print head 5, and the postage meter machine 1 changes its internal status such that only zero franking (frankings with the value zero) are permitted. Given an attempt to generate frankings with other postage values, in contrast, an indication appears to first transmit the serial number to the data center 6 and to register the printer unit or its location thereat. This can ensue by means of a remote recrediting during which what is referred to as an accompanying data transaction is implemented as an additional communication step. Given a successful transaction, an enable code is transmitted from the data center 6 to the postage meter machine 1, after which the internal status of the postage meter machine 1 is reset, so that frankings can be normally generated. The transmitted information code is interpreted in the data center 6 in a following data processing device, and, for example, a report is generated that enables an allocation of customer, meter and base unit data.

This data transaction between the postage meter machine 1 and data center 6 can be implemented encrypted or non-encrypted. Given a non-encrypted transaction, this is merely secured by the communication protocol according to the X.25 standard. In order nonetheless to prevent third parties from simulating a manipulation of a postage meter machine 1, this transaction is only accepted by the data center 6 if it was implemented following a cryptographically secured transaction, for example a remote valuing. Each transaction between the postage meter machine 1 and the data center 6 is divided into an identification phase and a message transmission phase.

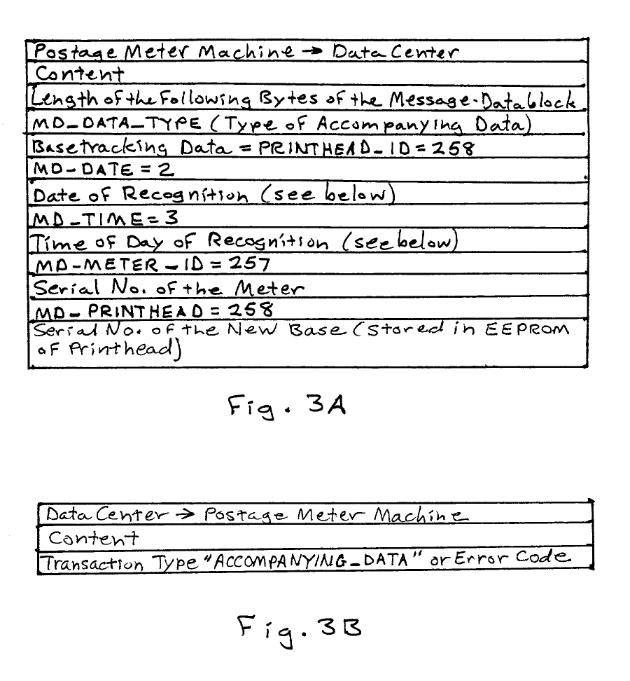

Exemplary protocols of the identification protocol are shown in FIG. 2A, which shows the protocol in the transmission from the postage meter machine 1 to the data center 6, and FIG. 2B, which shows the reply protocol from the data center 6 to the postage meter machine 1.

Exemplary protocols for the message transmission phase are shown in Figure 3A which shows a protocol for the data transmission from the postage meter machine 1 to the data center 6, and FIG. 3B, which shows the reply protocol from the data center 6 to the postage meter machine 1.

The return transmission of the transaction type “accompanying data” is evaluated in FIG. 3B as a successful termination of the transaction, after which the postage meter machine 1 is reset as to its status, and thus permits frankings with a franking value greater than zero. If, instead, the data center 6 returns an error code to the postage meter machine 1, the postage meter machine 1 does not change status and continues to permit only zero frankings. This can be the case when the interpretation of the data transmitted from the postage meter machine 1 to the data center yields a suspected manipulation in the data center 6. For example, a resetting of the status of the postage meter machine 1 can be delayed until an inspection of the postage meter machine 1 has ensued.

The illustrated embodiment of the inventive system for franking postal matter and the illustrated protocols are only an example, since many variations with respect to the specific embodiment are conceivable. In particular, thus, the specific realization of the individual component parts of the postage meter machine 1 and of the printer unit 4 as well as the type of coupling between the postage meter machine 1 and the data center 6 are not critical to the invention.

We claim as our invention:

1. A method for enabling a postage meter machine for franking postal matter comprising the steps of:
providing a base unit with a printer unit, having an identification code, for printing franking imprints on postal matter respectively representing monetary values that are debited in an accounting unit in said meter;
coupling said base unit to a meter to form a postage meter machine;
after coupling said meter and base unit, and before initialization of said postage meter machine, establishing communication between said postage meter machine and a data center remote from said postage meter machine and transmitting said identification code from said postage meter machine to said data center;
at said data center, evaluating said identification code and, if said identification code is valid, transmitting an enable code from said data center to said postage meter machine; and
allowing said postage meter machine to frank postal items only after said enable code is transmitted to said postage meter machine.

2. A method as claimed in claim 1 comprising providing said printer unit with a serial number and using said serial number as said identification code.

3. A method as claimed in claim 2 comprising assigning said serial number to said printhead upon manufacture of said print head, and storing said serial number in an electronic memory associated with said printhead.

4. A method as claimed in claim 1 comprising, after establishing communication between said postage meter machine and said data center, executing a remote recrediting between said postage meter machine and said data center with an additional data transmission for transmission of said identification code.

5. A method as claimed in claim 1 comprising storing said identification code at said data center allocated to additional data selected from the group consisting of customer data, postage meter machine data and time data.

6. A method as claimed in claim 1 comprising tracking a location of said base unit and said printer unit at said data center dependent on said identification code transmitted to said data center.

7. A method as claimed in claim 1 comprising cryptographically encrypting said transmission between said postage meter machine and said data center.

8. A system for franking postal items, comprising:
a postage meter machine comprising a meter coupled to a base unit, with a printer unit in communication with said meter for producing franking imprints on postal items with respective values of said franking imprints being debited in an accounting unit in said meter, said printer unit having an identification code;
a data center located remote from said postage meter machine;
said postage meter machine having a communication arrangement which, after coupling said meter to said base unit, establishes communication with said data center and transmits said identification code to said data center;
an evaluation arrangement at said data center for evaluating said identification code and, if said evaluation code is valid, for transmitting an enable code from said data center to said postage meter machine; and
enabling circuitry in said postage meter machine for enabling said printer unit to generate said franking imprints only after said postage meter machine receives said enable code.

9. A system as claimed in claim 8 wherein said data center includes a memory for storing said identification code allocated to further data, selected from the group consisting of customer data, postage meter machine data and time data.

10. A system as claimed in claim 8 wherein said data center includes a tracking unit for tracking a location of said base unit and said printer unit dependent on said identification code transmitted to said data center, and for detecting tampering at said postage meter machine dependent on said tracking.

11. A postage meter machine comprising:
a base unit;
a meter coupled to said base unit and a printer unit in communication with said meter, said printer unit producing franking imprints on postal items with respective franking values debited in an accounting unit in said meter, said printer unit having an identification code;
a communication arrangement adapted to establish communication between said postage meter machine and a data center remote therefrom which, after coupling said base unit and said meter and before initialization of said meter, transmits said identification code to said data center; and
an enabling circuit allowing said printer unit to generate said franking imprints only after receipt of an enable code at said postage meter machine from said data center in response to transmission of said identification code.
